(19) United States
(12) Patent Application Publication
(10) Pub. No.: US 2023/0122132 A1
(43) Pub. Date: Apr. 20, 2023

(54) SYSTEMS AND METHODS FOR ROUTING VEHICLES VIA RAIL AND ROAD

(71) Applicant: TOYOTA MOTOR NORTH AMERICA, INC., Plano, TX (US)

(72) Inventor: Eric E. Delp, Frisco, TX (US)

(21) Appl. No.: 17/502,473

(22) Filed: Oct. 15, 2021

(51) Int. Cl. G08G 7/00; B60F 1/04; G08G 1/01

(52) U.S. Cl. CPC G08G 7/00; B60F 1/04; G08G 1/0104

(57) ABSTRACT

System and methods for routing vehicles via rail and road are provided. One or more rail vehicles (e.g., trains, light rail, or other vehicles that travel exclusively via rail, etc.) and one or more hybrid vehicles that travel on road and rail may be tracked or monitored. The hybrid vehicle may be routed off the rail, such as onto an intersecting road, when a rail line interference or conflict exists with one or more rail vehicles.

### TECHNICAL FIELD

The present disclosure relates generally to vehicle routing, and, more particularly, to systems and methods for routing vehicles via rail and road.

### BACKGROUND

Some cites have train tracks or rail lines that transport trains, light rail, or other vehicles along the rails. In addition, some hybrid vehicles (e.g., hi-rail vehicles, dual-mode vehicles, etc.) can travel along roads and rails. These hybrid vehicles can be used to reduce traffic congestion by traveling on rail where available and by road when rail is not available.

### BRIEF SUMMARY

Various embodiments of the present disclosure include a vehicle management system. The vehicle management system includes a first module, a second module, and a third module. The first module may be configured to monitor a first condition of a rail vehicle operating on a rail line. The second module may be configured to monitor a second condition of a vehicle configured to travel by road and the rail line. The third module may be configured to route the vehicle on the road and rail line based on the first condition and the second condition. The third module may route the vehicle off the rail line and onto the road based on a rail line conflict with the rail vehicle.

Various embodiments of the present disclosure include a system. The system includes a vehicle configured to operate on both a road and a rail line, and a logic device. The logic device may be configured to monitor a first condition of a rail vehicle operating on the rail line, monitor a second condition of the vehicle, and route the vehicle on the road and rail line based on the first condition and the second condition. The vehicle may be routed off the rail line and onto the road based on a rail line conflict with the rail vehicle.

Various embodiments of the present disclosure include a method of routing a hybrid vehicle on road and rail. The method may include monitoring a first condition of a rail vehicle operating on a rail line, monitoring a second condition of a hybrid vehicle configured to travel by road and the rail line, and routing the hybrid vehicle on the road and the rail line based on the first condition and the second condition. The hybrid vehicle may be routed off the rail line and onto the road based on a rail line conflict with the rail vehicle.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

Aspects of the present disclosure are best understood from the following detailed description when read with the accompanying figures.

FIG. 1 is an illustration of a vehicle that has been outfitted to travel by road and rail line, according to one or more embodiments of the disclosure.

FIG. 2A is a front view of a rail adapter allowing a vehicle to travel by rail line, according to one or more embodiments of the disclosure.

FIG. 2B is a side view of the rail adapter of FIG. 2A, according to one or more embodiments of the disclosure.

FIG. 3 is an illustration of a hybrid vehicle configured to travel by road and rail line, according to one or more embodiments of the disclosure.

FIG. 4 is an illustration of a group of hybrid vehicles platooned or flocked together, according to one or more embodiments of the disclosure.

FIG. 5 is an illustration of a transfer station allowing one or more passengers to board or disembark a hybrid vehicle, according to one or more embodiments of the disclosure.

FIG. 6 is an illustration of a platform allowing one or more passengers to board or disembark a hybrid vehicle, according to one or more embodiments of the disclosure.

FIG. 7 is an illustration of an intersection of a road and rail line that allows one or more hybrid vehicles to transition between the road and rail line, according to one or more embodiments of the disclosure.

FIG. 8 is an illustration of traffic congestion and hybrid vehicle routing, according to one or more embodiments of the disclosure.

FIG. 9 is an illustration of a transportation system utilizing one or more hybrid vehicles, according to one or more embodiments of the disclosure.

FIG. 10 is an illustration of an automated driving system for a hybrid vehicle, according to one or more embodiments of the disclosure.

FIG. 11 is a flowchart of a method of routing a vehicle on road and rail, according to one or more embodiments of the disclosure

FIG. 12 is a diagram illustrating an example computing or processing system, according to one or more embodiments of the disclosure.

### DETAILED DESCRIPTION

Embodiments of the present disclosure are directed to system and methods for routing vehicles that travel via rail and road. Rail vehicles (e.g., trains, light rail, or other vehicles that travel exclusively via rail, etc.) and hybrid vehicles that travel on road and rail may be tracked or monitored. For example, a system may receive locations, speeds, and/or schedules of rail vehicles and route hybrid vehicles such that the hybrid vehicles travel along a rail during times and locations when the rail is not being used by other vehicles. In embodiments, the system may route the hybrid vehicles off the rail (e.g., onto stations or side roads) when interference or conflict exists with one or more rail vehicles (e.g., if interference/conflict on the rail is imminent). In the case that two hybrid vehicles come into conflict, the system will determine which vehicle has the more optimum road route and route that vehicle off the road so that time for both vehicles is maximized. In the rerouting calculation, the system will also consider destination arrival time per the original schedule to maintain the closest planned arrival time for both hybrid vehicles.

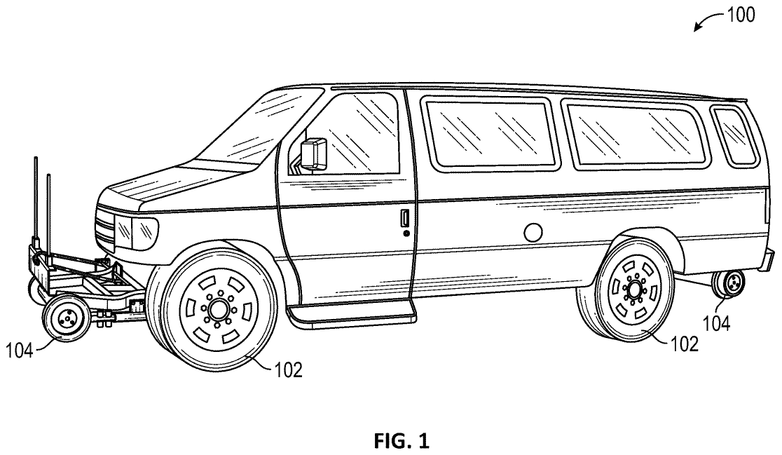

FIG. 1 is an illustration of a vehicle that has been outfitted to travel by road and rail line, according to one or more embodiments of the disclosure. Referring to FIG. 1, a vehicle 100 (e.g., a truck, a van, a car, a bus, etc.) may be configured to operate both on rail tracks and a conventional road. The vehicle 100, which may be referred to as a hybrid vehicle, a hi-rail vehicle, or simply a hi-rail, may be a converted road vehicle. For example, the vehicle 100 may include roadway tires 102, but outfitted with additional flanged wheels 104 (e.g., flanged steel wheels) that, when deployed, allow the vehicle 100 to travel on railways or rail lines. Propulsion may be generated by the roadway tires 102, with the flanged wheels 104 often free rolling. Directional control is based on rail construction, eliminating the need for steering on the rail line. In such embodiments, steering locks may be installed to limit the potential for derailment.

The vehicle 100 may be set on a rail line in many configurations. For example, the vehicle 100 may be pulled up onto the track (e.g., after checking to make sure there is no oncoming road traffic or trains on adjacent tracks). The roadway tires 102 are lined up with the rails, and the flanged wheels 104 are deployed, such that flanges of the flanged wheels 104 fit inside the rails. The vehicle 100 may be removed from the rail line using a reverse order. For instance, the flanged wheels 104 may be lifted from the rails and the vehicle 100 pulled away from the rail line.

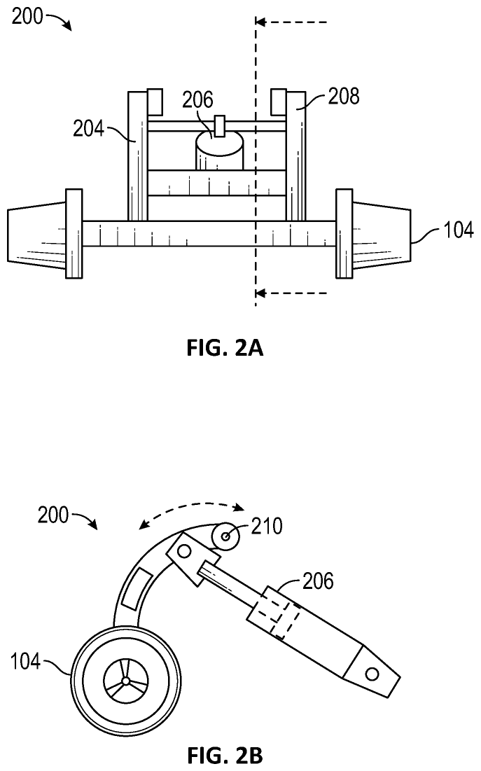

FIGS. 2A-2B are illustrations of an exemplary rail adapter 200 allowing a vehicle to travel by rail line, according to one or more embodiments of the disclosure. FIG. 2A is a front view of the rail adapter 200. FIG. 2B is a side view of the rail adapter 200. Referring to FIGS. 2A-2B, the rail adapter 200 may be installed on a road vehicle (e.g., vehicle 100) to allow the road vehicle to selectively operate on a rail line. For example, the rail adapter 200 may be connected to the frame of the road vehicle, such as at the front and rear of the road vehicle. As shown, the rail adapter 200 includes the flanged wheels 104 and a deployment mechanism 204 configured to selectively deploy the flanged wheels 104 onto rails. The deployment mechanism 204 may move the flanged wheels 104 into position on the rails. For example, the deployment mechanism 204 may include an actuator 206 (e.g., a linear or rotary actuator) and an arm 208. The flanged wheels 104 may be connected to the arm 208. The arm 208 may rotate about an axis 210, such as via the actuator 206, to move the flanged wheels 104 into and out of position on the rails. The rail adapter 200 illustrated in FIGS. 2A-2B is exemplary only, and the rail adapter 200 may include other configurations.

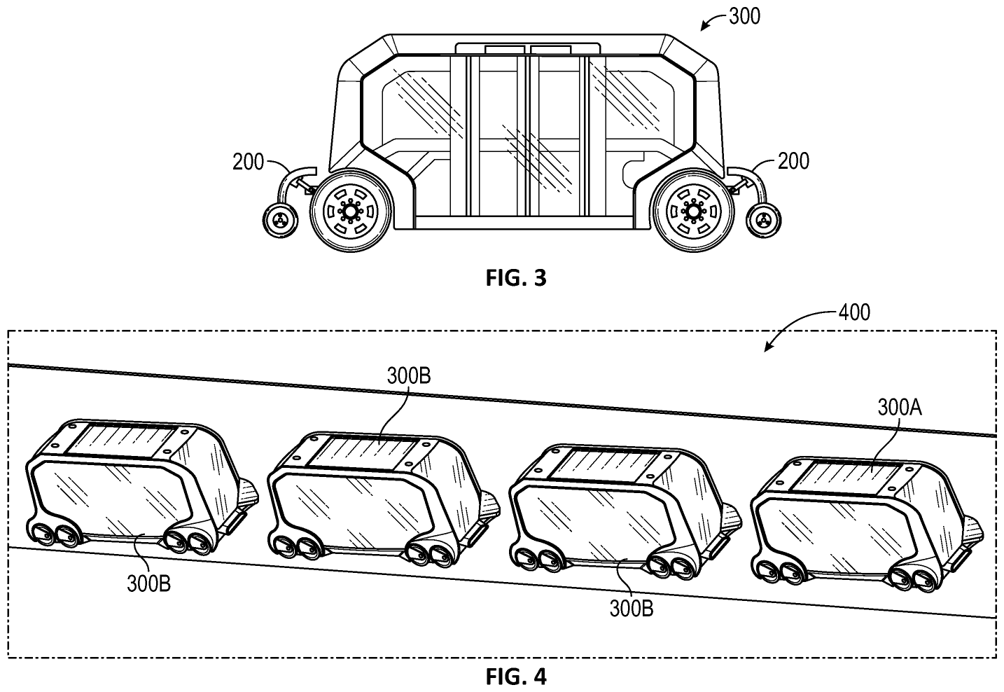

Although described with reference to outfitting an existing road vehicle, in some embodiments, the rail adapter 200 may be a standard feature of a purpose-built vehicle designed to operate both on a rail line and a conventional road. For example, FIG. 3 is an illustration of a hybrid vehicle 300 purpose-built to travel by road and rail line, according to one or more embodiments of the disclosure. Referring to FIG. 3, the hybrid vehicle 300 may be a flexible, purpose-built vehicle for transportation, shipping, and other solutions. In embodiments, the hybrid vehicle 300 may be part of a mobile services platform (MSPF) providing a suite of connected mobile services, such as ride connections, schedules, ETA, seat reservations, payment and ticketing. As shown, the hybrid vehicle 300 may be a multi-passenger vehicle designed for mass transportation (e.g., as part of a public transportation system), although other configurations are contemplated.

FIG. 4 is an illustration of a group of hybrid vehicles 300 platooned or flocked together, according to one or more embodiments of the disclosure. Referring to FIGS. 3-4, the hybrid vehicle 300 may be an autonomous vehicle (e.g., a self-driving vehicle, driverless vehicle, or robo-vehicle) capable of sensing its environment and moving safely with little or no human input. For example, the hybrid vehicle 300 may include advanced control systems that interpret sensory information to identify appropriate navigation paths, as well as obstacles and relevant signage. Referring to FIG. 4, a group of hybrid vehicles 300 may be platooned or flocked together (e.g., creating a platoon 400). For example, a group of hybrid vehicles 300 may be placed in an autonomous tow configuration, with a lead hybrid vehicle 300A and multiple hybrid vehicles 300B in autonomous tow, allowing many hybrid vehicles 300 to accelerate or brake simultaneously, increasing transportation capacity (e.g., to provide a light rail-type service). In embodiments, one or more hybrid vehicles 300 may leave the platoon 400 and/or additional hybrid vehicles 300 may join the platoon 400, such as automatically, based on individual destination and travel paths of each hybrid vehicle 300.

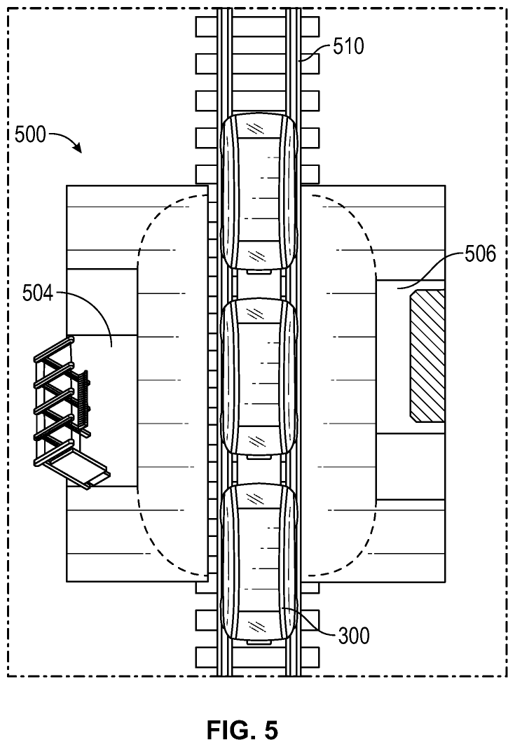

FIG. 5 is an illustration of a transfer station 500 allowing one or more passengers to board or disembark a hybrid vehicle 300, according to one or more embodiments of the disclosure. Referring to FIG. 5, the transfer station 500 may include one or more platforms facilitating boarding, loading and/or unloading of one or more hybrid vehicles 300. For instance, the transfer station 500 may include a passenger platform 504, a materials loading/unloading dock 506, or any combination thereof. Depending on the embodiment, passengers may board or disembark on a first platform (e.g., passenger platform 504), and materials may be loaded or unloaded on a second platform (e.g., dock 506), although other configurations are contemplated. As shown, the transfer station 500 may be positioned along a rail line 510, such as adjacent to the rail line 510 for ease of access to the rail line 510 by the hybrid vehicle(s) 300. In some embodiments, the hybrid vehicle(s) 300 may be removed from the rail line 510 for passenger/material loading/unloading, such as to allow other hybrid vehicles or rail vehicles (e.g., trains) to utilize the rail line 510 during loading/unloading. Once loaded or unloaded at the transfer station 500, the hybrid vehicle(s) 300 may be set back on the rail line 510 for continued operation. Although shown as adjacent to rail line 510, the transfer station 500 may be positioned along well-traveled roadways. For instance, one or multiple transfer stations 500 may be placed strategically around town as part of a public transportation network. In addition, multiple transfer stations 500 may be placed strategically along rail lines 510, based on public transportation needs and projections.

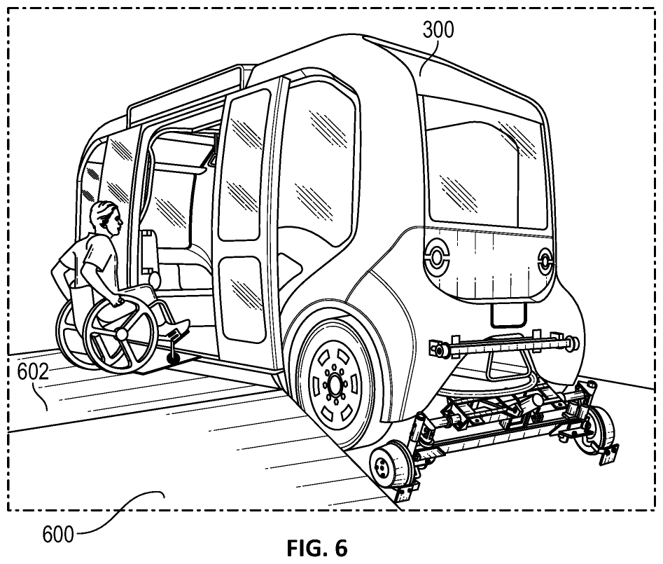

FIG. 6 is an illustration of a platform 600 allowing one or more passengers to board or disembark a hybrid vehicle 300, according to one or more embodiments of the disclosure. The platform 600 may be part of transfer station 500. The platform 600 may include an elevated surface 602 facilitating boarding and/or unloading of hybrid vehicle 300, such as for individuals with disabilities, injuries, or other mobility accommodations. For example, the elevated surface 602 may be on the same level as a floor of the hybrid vehicle 300 for ease of transition between the platform 600 and hybrid vehicle 300.

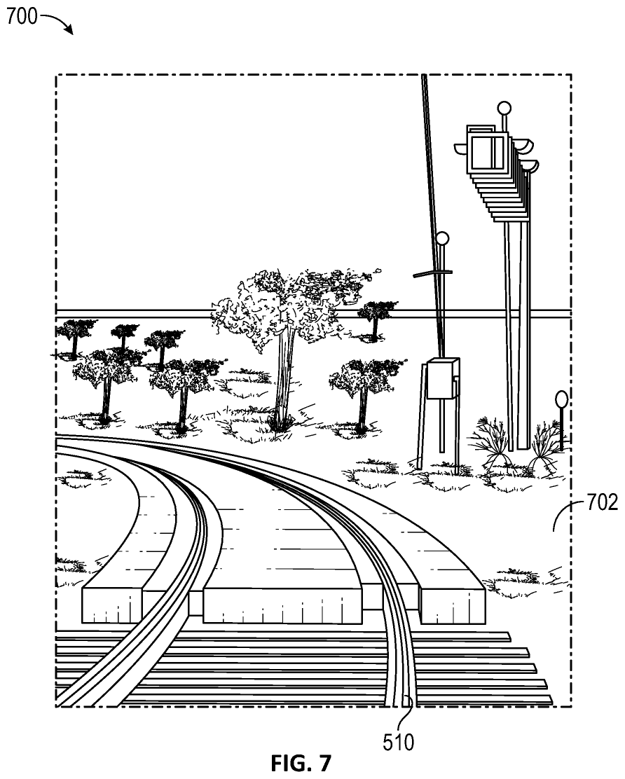

FIG. 7 is an illustration of an intersection 700 of a road and rail line that allows one or more hybrid vehicles to transition between the road and rail line, according to one or more embodiments of the disclosure. In addition to transferring on and off rail line 510 at transfer station 500, the hybrid vehicle 300 may transition between rail line 510 and a roadway 702 at any suitable intersection 700 of the two. In this manner, the hybrid vehicle 300 may switch between rail line and roadway operations as desired, such as to increase transportation efficiency (e.g., to reduce travel times to a destination), allow higher priority vehicles to use the rail line 510 (e.g., when a conflict exists with one or more trains or other rail vehicles), or the like, as explained more fully below. As a result, the hybrid vehicle 300 may be free to utilize either rail line 510 or roadway 702 based on needs, logistics, trip routing, or the like.

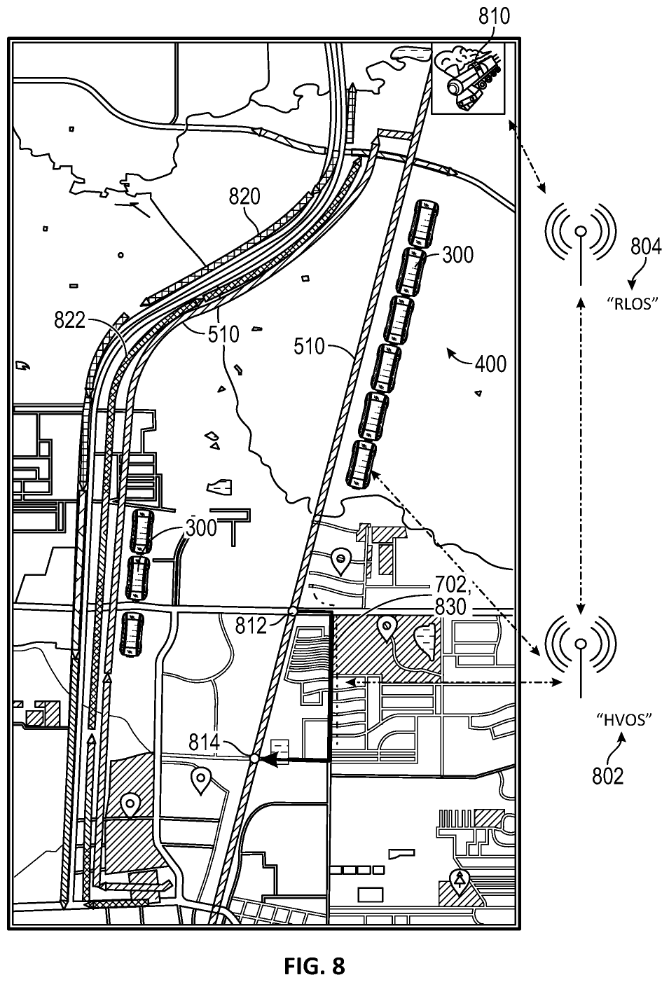

FIG. 8 is an illustration of traffic congestion .and hybrid vehicle routing, according to one or more embodiments of the disclosure. Referring to FIG. 8, one or more hybrid vehicles 300 may be routed along a combination of surface streets (e.g., roadway 702) and rail lines (e.g., rail line 510). For example, the hybrid vehicle(s) 300 may travel along one or more rail lines during times and locations when the rail lines are not being used, and along one or more surface streets when a conflict exists with one or more rail vehicles (e.g., based on rail line schedule or utilization, etc.). In this manner, hybrid vehicle 300 may be used to disperse traffic congestion (e.g., to quickly disperse traffic congestion, such as large event traffic congestion).

In embodiments, the hybrid vehicle 300 or a hybrid vehicle operations system (HVOS) 802 (or simply vehicle management system) may communicate with a rail line operations system (RLOS) 804 to coordinate movement of the hybrid vehicle 300 and a rail vehicle 810 (e.g., a train, light rail, etc.). The HVOS 802 and RLOS 804 may coordinate locations, speeds, and/or schedules of the hybrid vehicle 300 and rail vehicle 810 to determine if a rail line conflict exists, such as determining times and locations when rail line 510 is being used. The HVOS 802 and RLOS 804 may communicate via various protocols, such as via wireless or wired protocols.

Based on the coordinated movement of hybrid vehicle 300 and rail vehicle 810 on rail line 510, the hybrid vehicle 300 may be routed off the rail line 510. For example, when a rail line conflict exists based on locations, speeds, schedules, and destinations of hybrid vehicle 300 and rail vehicle 810, hybrid vehicle 300 may be routed off the rail line 510 (e.g., re-routed) and onto one or more side roads (e.g., roadway 702), such as at a first intersection or access location 812 along the rail line 510. When the rail line conflict no longer exists, the hybrid vehicle 300 may be routed back onto the rail line 510, such as at a second intersection or access location 814 along the rail line 510.

With continued reference to FIG. 8, the HVOS 802 may remotely manage the hybrid vehicle 300 by designing an optimal route based on road traffic and rail traffic. For instance, hybrid vehicle 300 may be routed by rail based on traffic congestion (e.g., when traveling by rail would be quicker or more efficient). As noted above, hybrid vehicle 300 may be routed by road based on rail traffic (e.g., when a rail line conflict exists). In addition, hybrid vehicle 300 may be routed by road when traveling by road would be quicker or more efficient. For example, as shown in FIG. 8, hybrid vehicle 300 may utilize rail line 510 in a roadway congested direction 820, while utilizing an uncongested road 822 to return (e.g., even if a rail line conflict does not exist). In embodiments, hybrid vehicle 300 may utilize an uncongested rail line or roadway during the entire trip or distance travelled. Communication with RLOS 804 may direct hybrid vehicle 300 onto a low congestion route 830 when rail vehicle 810 (e.g., freight train, etc.) needs to pass on rail line 510.

In some embodiments, hybrid vehicle 300 may be routed on or off rail line 510 based on a preference mode. For instance, routing of hybrid vehicle 300 may occur primarily via rail line 510 or roadway 702 based on local, regional, or national requirements, regulations, or directives. In some embodiments, one or more hybrid vehicles 300 of a platoon 400 may be routed off rail line 510 while the remaining hybrid vehicles 300 remain on the rail line 510, such as based on individual characteristics, schedules, and destinations of each hybrid vehicle 300.

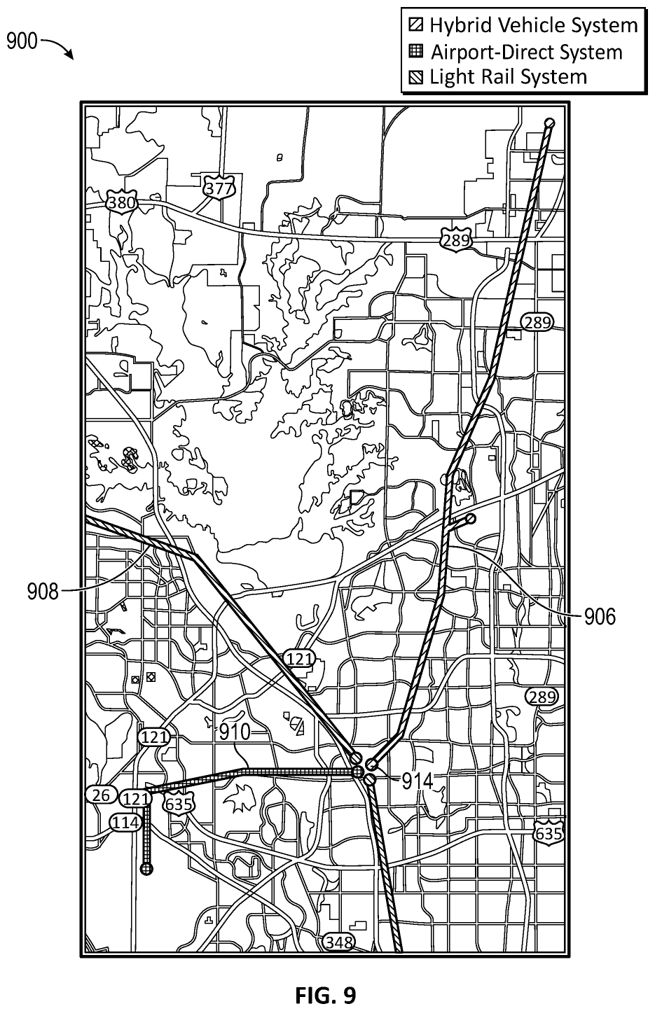

FIG. 9 is an illustration of a transportation system 900 utilizing one or more hybrid vehicles, according to one or more embodiments of the disclosure. Depending on the application, the transportation system 900 may be a public transport system or a private transport system. As a result, hybrid vehicle 300 may utilize current rail tracks (e.g., freight rails, light rails, etc.) to move people as part of a public or private transport system. As shown, the transportation system 900 may include multiple transit systems, such as one or more hybrid vehicle systems 906, light rail systems 908, airport-direct systems 910, bus systems, or any combination thereof. The hybrid vehicle(s) 300 may integrate with the other transit systems of transportation system 900. For example, one or more hybrid vehicles 300 may operate to transport passengers along a first route, with one or more other transit systems operating to transport passengers along different routes. The various transit systems may intersect at various locations (e.g., at one or more hubs 914) to allow passengers to access the various routes.

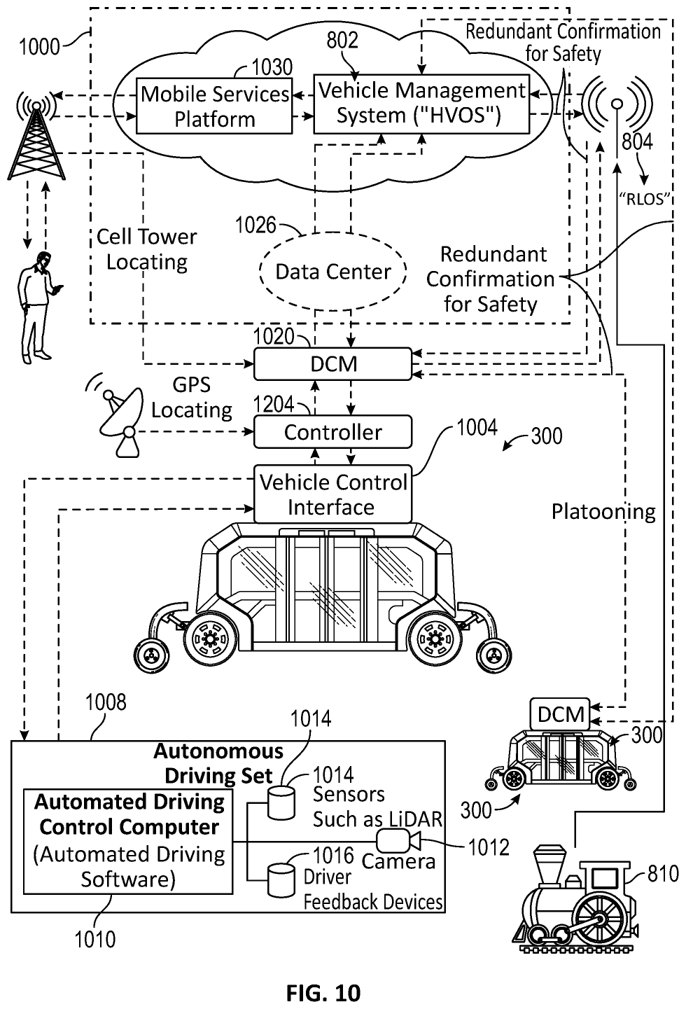

FIG. 10 is an illustration of a vehicle routing system 1000 for a hybrid vehicle, according to one or more embodiments of the disclosure. The vehicle routing system 1000 may include various modules, systems, subsystems, platforms, hardware and/or software to route hybrid vehicle 300 via rail and road. For example, vehicle routing system 1000 may, individually or collectively, include one or more processors, hardware logic, and/or control software to route hybrid vehicle 300 on and off rail line 510 and/or other rail lines, for the purposes explained above. Depending on the embodiment, vehicle routing system 1000 may include a data center 1026, a mobile services platform (MSPF) 1030, HVOS 802, or any combination thereof. Vehicle routing system 1000 (e.g., data center 1026, HVOS 802, MSPF 1030, or any combination thereof) may perform route calculations and directions for hybrid vehicle 300, such as based on information (e.g., locations, speeds, schedules, etc.) received from HVOS 802 and/or RLOS 804. In embodiments, vehicle routing system 1000 may control the routes of multiple hybrid vehicles 300, routing the vehicles centrally and sending route directions to the vehicles.

Although described as performed remotely from hybrid vehicle 300, the route calculations and directions may be completed, at least partially, by the hybrid vehicle 300 itself (e.g., on board route guidance/control). For instance, hybrid vehicle 300 may include redundant hardware and/or software to perform the route calculations and directions, such as when communication with vehicle routing system 1000 is interrupted, non-functioning, partial, or non-existent. As a result, various calculations and/or communications may be redundant for safety. For example, vehicle communication with RLOS 804 may occur indirectly via HVOS 802 and/or directly from hybrid vehicle 300. Similarly, platooning communication between multiple vehicles may occur indirectly via HVOS 802 and/or directly between the hybrid vehicles 300.

With continued reference to FIG. 10, hybrid vehicle 300 includes a data communication module (DCM) 1020 configured to communicate with the vehicle routing system 1000, one or more mobile networks, the cloud, and/or the internet. For example, DCM 1020 may communicate various vehicle information (e.g., speed, location, automated driving state, etc.) with data center 1026, HVOS 802, and/or MSPF 1030. Similarly, DCM 1020 may receive various data from MSPF 1030, data center 1026, and/or HVOS 802, such as data associated with other vehicles in the network, routing commands, route information, network status, or the like.

As noted above, hybrid vehicle 300 may be an autonomous vehicle, such as a partially (level 2-4) or fully (level 5) autonomous vehicle. As shown in FIG. 10, a vehicle control interface (VCI) 1004 may receive various vehicle information from hybrid vehicle 300. Vehicle information received by the VCI 1004 may include location, speed, stopping, turning, HUD, remaining fuel/charge, SOS, on rail or off rail, congestion, or other information. The vehicle information (i.e., the vehicle state) may be communicated to an autonomous driving set (ADS) 1008. The ADS 1008 may include an automated driving control computer 1010 (with automated driving software) that communicates and receives information from one or more sensors or devices (e.g., a camera 1012, sensors such as LiDAR 1014, or other driver feedback devices 1016). The ADS 1008 may provide one or more control commands to the VCI 1004 to control operation of hybrid vehicle 300 (e.g., running, stopping, turning, etc.).

The hybrid vehicle 300 is proposed as a level 2-5 autonomous vehicle with driver on board to interact and control the vehicle at any time. The VCI 1004 may provide safety data and ability for on rail driver interaction free transport on rail. The level of autonomous driving capability can be chosen by the transportation client considering regulation, prices, use case and level of available autonomous driving technology. Such examples are exemplary only, and the hybrid vehicle 300 may not be an autonomous vehicle in some embodiments.

In some embodiments, rider data (e.g., ticketing, reservations, ETA, schedule, payment, A to B connections, autonomous lanes, road signal communications, etc.) may be communicated from MSPF 1030 related to automated and/or non-automated driving. In some embodiments, MSPF 1030 may provide updated software for various modules or systems of hybrid vehicle 300 and/or vehicle routing system 1000 (e.g., ADS 1008, HVOS 802, etc.). As shown, the vehicle routing system 1000 may use cell tower locating and/or GPS locating to facilitate routing of hybrid vehicle 300.

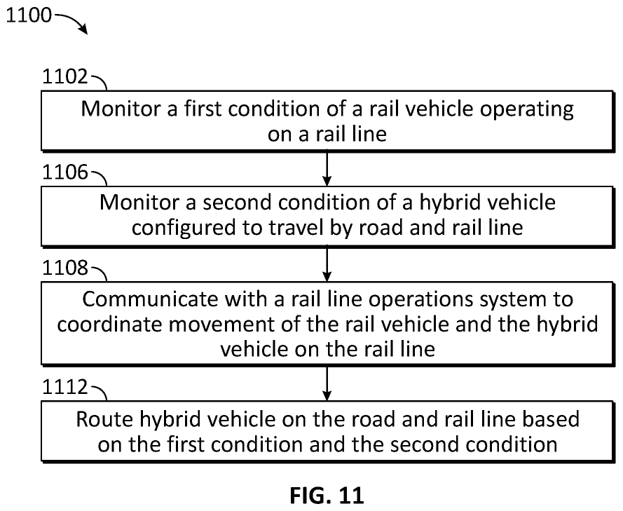

FIG. 11 is a flowchart of a method 1100 of routing a vehicle (e.g., vehicle 100 or hybrid vehicle 300) on road and rail, according to one or more embodiments of the disclosure. Method 1100 may be implemented using various systems, such as a vehicle management system (e.g., HVOS 802), a transportation system (e.g., vehicle routing system 1000), or the like. Method 1100 is illustrated as a set of operations or steps and is described with reference to FIGS. 1-10, although method 1100 may be applied to other embodiments not illustrated in FIGS. 1-10. One or more steps that are not expressly illustrated in FIG. 11 may be included before, after, in between, or as part of the illustrated steps.

In block 1102, method 1100 includes monitoring a first condition of a rail vehicle operating on a rail line. For example, rail vehicle 810, as well as other rail vehicles, may be monitored as the one or more rail vehicles operate on rail line, as described above. Block 1102 may include monitoring at least one of a location, velocity, or schedule of the rail vehicle. In embodiments, block 1102 may be performed by RLOS 804 and/or a different system described above.

In block 1106, method 1100 includes monitoring a second condition of a hybrid vehicle configured to travel by road and rail line. For example, vehicle 100, hybrid vehicle 300, and/or another vehicle may be monitored as the vehicle operates on road and rail. Block 1106 may include monitoring at least one of a position, speed, or destination of the hybrid vehicle. Hybrid vehicle may be part of a public transportation network. In embodiments, block 1106 may be performed by vehicle routing system 1000 or any subsystem thereof described above (e.g., HVOS 802, data center 1026, etc.).

In block 1108, method 1100 may include communicating with a rail line operations system (e.g., RLOS 804) to coordinate movement of the rail vehicle and the hybrid vehicle on the rail line. For example, locations, speeds, and/or schedules of rail vehicle and hybrid vehicle may be coordinated to determine if a rail line conflict exists, such as overlapping times and locations of rail vehicle and hybrid vehicle along the rail line (e.g., along the same section of rail line). Block 1108 may be performed by vehicle routing system 1000 or any subsystem thereof described above (e.g., HVOS 802).

In block 1112, method 1100 includes routing the hybrid vehicle on the road and the rail line based on the first condition and the second condition. Block 1112 may include routing the hybrid vehicle off the rail line and onto the road based on a rail line conflict with the rail vehicle. For instance, hybrid vehicle may be routed off the rail line to allow rail vehicle to pass. Block 1112 may include routing the hybrid vehicle onto the rail line at a first access location along the rail line, and routing the hybrid vehicle off the rail line at a second access location along the rail line. In embodiments, block 1112 may include routing the hybrid vehicle along a public transportation route. In the case that two hybrid vehicles come into conflict, block 1112 may include determining which vehicle has the more optimum road route and, as a result, route that vehicle off the road so that time for both vehicles is maximized. The rerouting calculation may consider destination arrival time per the original schedule to maintain the closest planned arrival time for both hybrid vehicles. In embodiments, block 1112 may be performed by vehicle routing system 1000 or any subsystem thereof described above (e.g., HVOS 802, data center 1026, etc.).

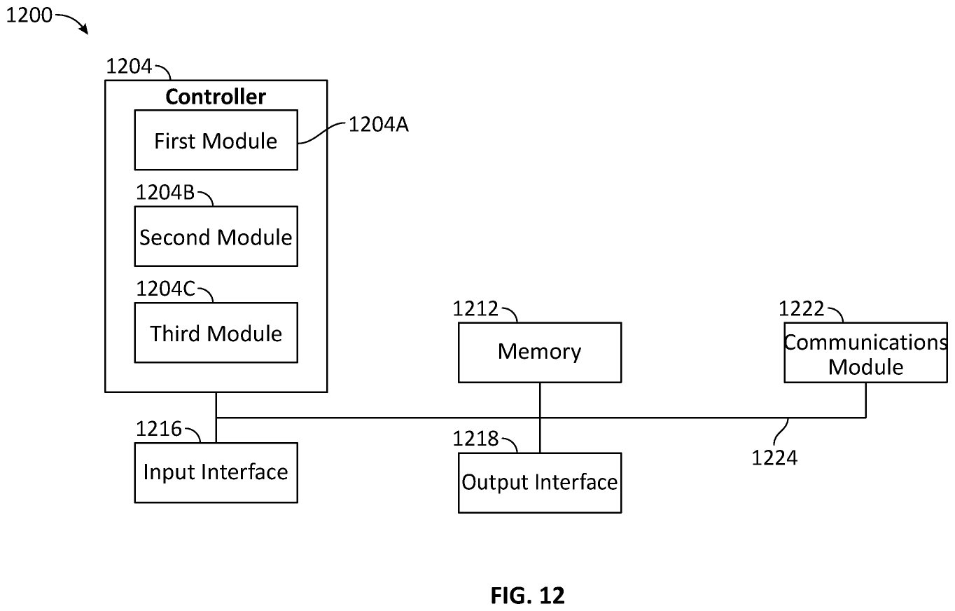

FIG. 12 is a diagram illustrating an example vehicle management system 1200, according to one or more embodiments of the disclosure. For example, vehicle 100 or hybrid vehicle 300 described above may include vehicle management system 1200 or at least a portion of vehicle management system 1200. For example, vehicle 100 or hybrid vehicle 300 may include portions of vehicle management system 1200, with the remaining portions located remotely. In embodiments, vehicle routing system 1000 (e.g., HVOS 802) may implement vehicle management system 1200 or at least a portion of vehicle management system 1200. In some embodiments, method of FIG. 11, as described above, may be implemented using vehicle management system 1200. Vehicle management system 1200 can be or include a computer, a logic device, or any other type of computing device. Such an electronic device includes various types of computer readable media and interfaces for various other types of computer readable media. As shown, vehicle management system 1200 includes a controller 1204, a memory 1212, an input interface 1216, an output interface 1218, and a communications module 1222.

The controller 1204, according to various embodiments, includes one or more of a processor, a microprocessor, a central processing unit (CPU), an electronic control unit, a graphics processing unit (GPU), a single-core processor, a multi-core processor, a microcontroller, a programmable logic device (PLD) (e.g., field programmable gate array (FPGA)), an application specific integrated circuit (ASIC), a digital signal processing (DSP) device, or other logic device that may be configured, by hardwiring, executing software instructions, or a combination of both, to perform various operations discussed herein for embodiments of the disclosure. The controller 1204 may be configured to interface and communicate with the various other components of the processing system to perform such operations. For example, the controller 1204 may be configured to receive and process position, speed, destination, and/or schedule data, among others, received from one or more networks and/or one or more sensors, store the data in the memory 1212, and/or retrieve stored data from the memory 1212.

The controller 1204 may include combinations of hardware and software processing functionality and may be provided with/in and/or communicatively attached to other components to execute appropriate instructions, such as software instructions and/or processing parameters stored in the memory 1212. In various embodiments, the controller 1204 may be configured to execute software instructions stored in the memory 1212 to perform various methods, processes, or operations in the manner described herein.

In embodiments, controller 1204 includes various modules, sub-controllers, or the like. For example, controller 1204 may include a first module 1204A, a second module 1204B, and a third module 1204C, or any combination thereof. The first module 1204A may be configured to monitor a first condition of a rail vehicle operating on a rail line (e.g., rail vehicle 810 operation on rail line 510, described above). For example, first module 1204A may be configured to communicate with a rail line operations system (e.g., RLOS 804, described above) to coordinate movement of rail vehicle and vehicle on rail line. The first condition may include at least one of a location, velocity, or schedule of the rail line. In embodiments, the first condition may include an utilization condition along the rail line.

The second module 1204B may be configured to monitor a second condition of a vehicle configured to travel by road and rail line (e.g., vehicle 100 and/or hybrid vehicle 300, described above). The second condition may include at least one of a position, speed, or destination of the vehicle. In embodiments, the second condition may include a congestion condition along nearby roadways. In some embodiments, the second module 1204B may be configured to receive an indication of a destination of the vehicle. For instance, the vehicle's destination may be set by a user interface, network directive, schedule, or the like.

The third module 1204C may be configured to route the vehicle on the road and rail line based on the first condition and the second condition. For example, the third module 1204C may route the vehicle from its current position to a destination using a combination of road and rail line, as explained above. In embodiments, the third module 1204C may route the vehicle off the rail line and onto a road based on a rail line conflict with a rail vehicle, as explained above. For instance, the third module 1204C may be configured to route the vehicle off the rail line at an intersection of the rail line with a side road, such as when a rail vehicle needs to pass on the rail line.

In embodiments, the third module 1204C may determine first and second access locations along the rail line allowing the vehicle to transition between road and rail line. The third module 1204C may route the vehicle onto the rail line at the first access location along the rail line. Similarly, the third module 1204C may route the vehicle off the rail line at the second access location along the rail line.

In embodiments, the third module 1204C may be configured to reroute the vehicle based on at least one of an updated first condition or an updated second condition. For example, the vehicle may be rerouted dynamically as congestion, rail way utilization, average speeds, route hazards, and destination (or other conditions) change.

The memory 1212 includes, in one embodiment, one or more memory devices configured to store data and information. The memory 1212 may include one or more various types of memory devices including volatile and non-volatile memory devices, such as random-access memory (RAM), dynamic RAM (DRAM), static RAM (SRAM), non-volatile random-access memory (NVRAM), read-only memory (ROM), programmable read-only memory (PROM), erasable programmable read-only memory (EPROM), electrically-erasable programmable read-only memory (EEPROM), flash memory, hard disk drive, and/or other types of memory. As discussed above, the controller 1204 may be configured to execute software instructions stored in the memory 1212 to perform method and process steps and/or operations. The controller 1204 may be configured to store data in the memory 1212.

The input interface 1216 includes, in one embodiment, a user input and/or an interface device, such as one or more knobs, buttons, slide bars, keyboards, sensors, cameras, and/or other devices, that are adapted to generate an input control signal. The controller 1204 may be configured to sense the input control signals from the input interface 1216 and respond to any sensed input control signals received therefrom. The controller 1204 may be configured to interpret such an input control signal as a value, as generally understood by one skilled in the art. In one embodiment, the input interface 1216 may include a control unit (e.g., a wired or wireless handheld control unit) having push buttons adapted to interface with a user and receive user input control values. In one implementation, the push buttons of the control unit may be used to control various system functions.

The output interface 1218 may enable, for example, the output of data or other information. The output interface 1218 may include, for example, one or more display devices, such as monitors or other visual displays (e.g., light emitting diode (LED) displays, liquid crystal displays (LCDs), head-up displays (HUDs), or other types of displays). Some implementations include devices such as a touchscreen that function as both input and output components. The controller 1204 may be configured to render data and information on the output interface 1218. For example, the controller 1204 may be configured to render data on the output interface 1218, such as data stored in the memory 1212.

In some embodiments, various components of system may be distributed and in communication with one another over a network. In this regard, system may include a communications module 1222 configured to facilitate wired and/or wireless communication among various system components over the network. Such a network may include, for example, a local area network (“LAN”), such as an Intranet, a wide area network (“WAN”), such as the Internet, or a cellular network (e.g., 3G/4G/5G).

In some embodiments, various components of system 1200 may be communicatively connected via a system communications bus 1224. Bus 1224 collectively represents all system, peripheral, and chipset buses that communicatively connect the numerous devices of system. For instance, bus 1224 may communicatively connect controller 1204, memory 1212, input interface 1216, output interface 1218, and communication module together.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

While certain exemplary embodiments of the invention have been described and shown in the accompanying drawings, it is to be understood that such embodiments are merely illustrative of and not restrictive on the broad invention, and that the embodiments of the invention not be limited to the specific constructions and arrangements shown and described, since various other modifications may occur to those ordinarily skilled in the art. The intention is to cover all modifications, equivalents and alternatives falling within the spirit and scope of the disclosure as defined by the claims.

For example, the elements and teachings of the various embodiments may be combined in whole or in part in some or all of the embodiments. In addition, one or more of the elements and teachings of the various embodiments may be omitted, at least in part, and/or combined, at least in part, with one or more of the other elements and teachings of the various embodiments. In addition, while different steps, processes, and procedures are described as appearing as distinct acts, one or more of the steps, one or more of the processes, and/or one or more of the procedures may also be performed in different orders, simultaneously, and/or sequentially. In some embodiments, the steps, processes, and/or procedures may be merged into one or more steps, processes, and/or procedures. In some embodiments, one or more of the operational steps in each embodiment may be omitted.

What is claimed is:

1. A vehicle management system comprising:
a first module configured to monitor a first condition of a rail vehicle operating on a rail line;
a second module configured to monitor a second condition of a vehicle configured to travel by road and the rail line;
a third module configured to route the vehicle on the road and rail line based on the first condition and the second condition, the third module routing the vehicle off the rail line and onto the road based on a rail line conflict with the rail vehicle.

2. The vehicle management system of claim 1, wherein the first module is configured to communicate with a rail line operations system to coordinate movement of the rail vehicle and the vehicle on the rail line.

3. The vehicle management system of claim 1, wherein:
the first condition comprises at least one of a location, velocity, or schedule of the rail line; and
the second condition comprises at least one of a position, speed, or destination of the vehicle.

4. The vehicle management system of claim 1, wherein the third module is configured to route the vehicle off the rail line at an intersection of the rail line with a side road.

5. The vehicle management system of claim 1, wherein:
the second module is configured to receive an indication of a destination of the vehicle; and
the third module is configured to route the vehicle from a current position to the destination using the road and rail line.

6. A transportation system comprising:
the vehicle management system of claim 1; and
the vehicle, wherein the vehicle is configured to operate on both the roadway and the rail line.

7. A method of operating the transportation system of claim 6, the method comprising:
monitoring the first condition of the rail vehicle;
monitoring the second condition of the vehicle; and
routing the vehicle on the road and the rail based on the first condition and the second condition.

8. A system comprising:
a vehicle configured to operate on both a road and a rail line; and
a logic device configured to:
monitor a first condition of a rail vehicle operating on the rail line,
monitor a second condition of the vehicle, and
route the vehicle on the road and rail line based on the first condition and the second condition, wherein the vehicle is routed off the rail line and onto the road based on a rail line conflict with the rail vehicle.

9. The system of claim 8, wherein:
the first condition comprises at least one of a location, velocity, or schedule of the rail line;
the second condition comprises at least one of a position, speed, or destination of the vehicle; and
the logic device is configured to communicate with a rail line operations system to coordinate movement of the rail vehicle and the vehicle on the rail line.

10. The system of claim 8, wherein the logic device is configured to:
determine first and second access locations along the rail line allowing the vehicle to transition between the road and rail line;
route the vehicle onto the rail line at the first access location along the rail line; and
route the vehicle off the rail line at the second access location along the rail line.

11. The system of claim 8, wherein the logic device is configured to:
receive an indication of a destination of the vehicle; and
route the vehicle from a current position to the destination using the road and rail line.

12. The system of claim 8, wherein the vehicle is at least one of a multi-passenger vehicle or an autonomous vehicle.

13. The system of claim 12, wherein the vehicle is part of a public transportation network.

14. The system of claim 8, wherein the logic device is configured to reroute the vehicle based on at least one of an updated first condition or an updated second condition.

15. A method of operating the system of claim 8, the method comprising:
monitoring the first condition of the rail vehicle;
monitoring the second condition of the vehicle; and
routing the vehicle on the road and the rail based on the first condition and the second condition.

16. A method comprising:
monitoring a first condition of a rail vehicle operating on a rail line;
monitoring a second condition of a hybrid vehicle configured to travel by road and the rail line; and
routing the hybrid vehicle on the road and the rail line based on the first condition and the second condition, wherein the hybrid vehicle is routed off the rail line and onto the road based on a rail line conflict with the rail vehicle.

17. The method of claim 16, further comprising communicating with a rail line operations system to coordinate movement of the rail vehicle and the hybrid vehicle on the rail line.

18. The method of claim 16, wherein the routing comprises:
routing the hybrid vehicle onto the rail line at a first access location along the rail line; and
routing the hybrid vehicle off the rail line at a second access location along the rail line.

19. The method of claim 16, wherein:
the monitoring the first condition comprises monitoring at least one of a location, velocity, or schedule of the rail vehicle; and
the monitoring the second condition comprises at least one of monitoring a position, speed, or destination of the hybrid vehicle.

20. The method of claim 16, wherein the hybrid vehicle is part of a public transportation network, and wherein the routing comprises routing the hybrid vehicle along a public transportation route.
